(19) United States
(12) Patent Application Publication
(10) Pub. No.: US 2009/0173537 A1
(43) Pub. Date: Jul. 9, 2009

(54) Switch with dustproof wire through feed

(75) Inventor: Henricus Cornelis Maria Hendriks, Eindhoven (NL)

Correspondence Address: DeMont & Breyer, LLC, 100 Commons Way, Ste. 250, Holmdel, NJ, 07733, US

(73) Assignee: ELECTRISCHE APPARATENFABRIEK CAPAX B.V., NL-5652 BA Eindhoven (NL)

(21) Appl. No.: 12/089,846

(22) PCT Filed: Oct. 5, 2006
(86) PCT No.: PCT/NL2006/050245

§ 371 Date: Jun. 9, 2008

(30) Foreign Application Priority Data
Oct. 11, 2005 (NL) 1030163

(51) Int. Cl. H02G 3/18

(52) U.S. Cl. 174/668

(57) ABSTRACT

The invention relates to a switch for electrical hand tools, comprising: a housing, switch means incorporated in the housing, at least one wire opening arranged in the housing for throughfeed of a connecting wire, at least one contact incorporated in the housing for making galvanic contact between a connecting wire placed through the opening and the switch means, and at least one sealing element fitting into the at least one wire opening, manufactured from a flexible material and provided with a throughfeed opening, wherein the sealing element has a first part in which a throughfeed opening has a diameter decreasing in the direction toward the interior of the housing. Due to this measure a very effective seal is obtained since the opening with decreasing diameter is widened slightly when the wire is inserted, whereby the seal is forced closely against the wire.

The invention relates to a switch for electrical hand tools, comprising a housing, switch means incorporated in the housing, at least one wire opening arranged in the housing for throughfeed of a connecting wire, and at least one contact incorporated in the housing for making galvanic contact between a connecting wire placed through the opening and the switch means, and at least one sealing element fitting into the at least one wire opening, manufactured from a flexible material and provided with a throughfeed opening.

Such switches are generally known. They are applied in, among other devices, electrical hand tools. Dust is released during the use of a number of types of electrical hand tool. This is the case with, among others, drilling, sawing, grinding and sanding machines. If the dust released during use penetrates into the switch, this dust can result in disruption of the movement of movable parts in the switch, or in additional wear. Only in extreme cases, such as in a moist environment, can the dust result in electrical failure, for instance in the case of moist wood dust.

When metal workpieces are however being machined, as is particularly the case with grinding machines, in particular right-angle grinders, there is the possibility of small metal particles entering the switch housing. This results in the danger of creepage currents and even short-circuiting, which in unfavourable situations can result in combustion.

The object of the invention is to provide a switch which also provides a sufficient sealing during operations where fine metal dust is released, so that the fine dust does not enter the switch.

This object is achieved in that the sealing element has a first part in which a throughfeed opening has a diameter decreasing in the direction toward the interior of the housing.

Due to this measure a very effective seal is obtained since the opening with decreasing diameter is widened slightly when the wire is inserted, whereby the seal is forced closely against the wire.

This effect is improved when the opening formed in its first part is at least partly conical.

A subsequent embodiment provides the measure that the sealing element has a second part in which the throughfeed opening is substantially cylindrical, and wherein the cylindrical part of the throughfeed opening connects to the part of the opening with the shape of a truncated cone at the end with the largest diameter. As a result of this measure a part of the wire extending through the cylindrical part of the throughfeed opening is not sealed, but this part is however prevented from being bent excessively. Lateral forces on that part of the wire extending through the actual sealing are hereby limited as much as possible. These lateral forces could after all result in a small displacement of the wire at the position of the seal, whereby the seal would no longer be able to function optimally.

Yet another embodiment provides the measure that the first part of the sealing element has a diameter which decreases toward the interior of the housing. The deformability, and thereby the elasticity, of the sealing part of the seal is hereby increased.

Such seals are usually manufactured by injection moulding, which involves the seal having to be released from a mould. This release is facilitated if the first part of the sealing element has the form of a truncated cone on its outer side.

Another embodiment provides the measure that the second part of the sealing element is enclosed on its periphery over at least a part of its height by the housing. Thus achieved is that the seal, usually manufactured from elastic material, is properly supported.

The sealing element is preferably provided with a fixation element for fixing the position of the sealing element relative to the housing. It hereby becomes possible for the sealing element to be placed with a loose fit in the wire opening of the housing, which improves the elasticity of the external support of the wire. It is however also possible for the fit of the sealing element in the housing to be such that the seal is hereby fixed.

A switch is necessarily provided with more than one connection. It is therefore attractive when at least two wire openings are arranged in the housing, each for throughfeed of a connecting wire, at least two contacts are arranged in the housing, each for making galvanic contact between a connecting wire placed through the opening and the switch means, a sealing element is placed fitting into each of the wire openings and the sealing elements are accommodated together in a single body.

The location of the connection of the wires to the switch is determined in the first instance by the placing of the various switch components inside the switch housing. It is however recommended that, when the at least two wire openings are arranged in the same wall, the body in which the at least two sealing elements are accommodated is formed by a substantially flat, plate-like body. It is hereby after all possible to provide two or more seals in a single component, which limits the number of operations during assembly.

The form of the body in which the seals are accommodated is simplified still further when the at least two wire openings are arranged in the same wall, and the body in which the at least two sealing elements are accommodated is formed by a substantially flat, plate-like body.

The function of the body can be enhanced when the plate-like body extends parallel to and on the inner side of a wall of the housing functioning as a cover of the housing and extends between the housing and the wall. The plate-like body hereby functions not only as a seal for the inlet for the wires, but also as seal for the switch cover.

The quality of the seal is improved when the throughfeed element is manufactured from a material with a hardness lying between 25 and 70 Shore A. The gap between the wire and the sealing body will hereby after all be filled more easily by the material of the seal.

The seal is preferably manufactured from polyamides, natural rubbers or synthetic rubbers.

It is attractive to construct switches which can be used for different configurations. It is then possible that in some switch configurations not all possible connections are used. With use of the seal according to the invention unconnected throughfeed openings remain open. In order to avoid this problem a preferred embodiment of the invention proposes that a thin wall which can be pierced when a wire is inserted is arranged in the throughfeed opening. Unconnected throughfeed openings hereby remain closed. The pierceable wall is preferably arranged in the throughfeed opening at the position with the smallest diameter.

The measure that the diameter of the insulated part of the wire is greater than the smallest diameter of the throughfeed opening results in a greater stress on the edge of the seal through which the wire extends.

The same advantages are achieved when the combination comprises at least two wires, wherein at least two wire openings, each for throughfeed of a connecting wire, are arranged for each of the wires in the housing, at least two contacts are arranged in the housing, each for making galvanic contact between a connecting wire placed through the opening and the switch means, a sealing element is placed fitting into each of the wire openings and the sealing elements are accommodated together in a single body.

The diameter of the wires leading from and to a switch will generally be the same. This does not however always have to be the case; control wires can for instance be connected to the switch, for which purpose a smaller diameter will suffice.

The present invention will be elucidated hereinbelow with reference to the accompanying drawings, in which:

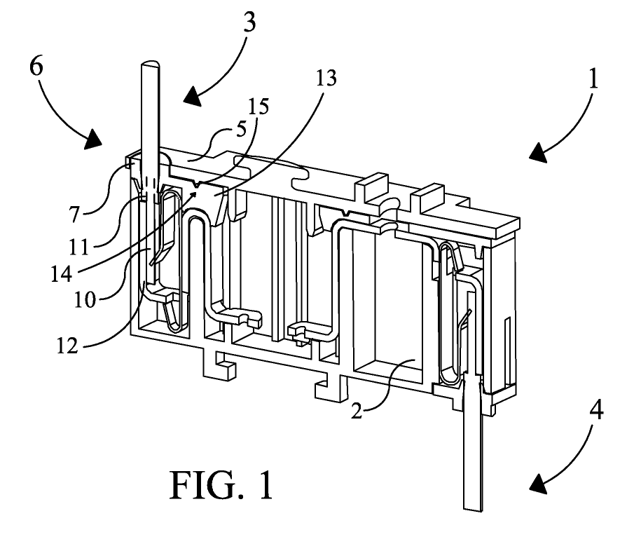

FIG. 1 is a perspective view of the inside of a switch according to the invention;

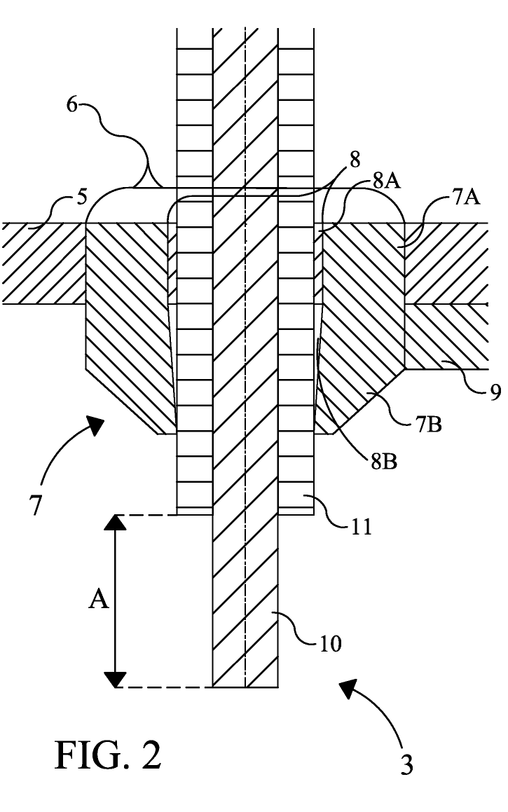

FIG. 2 is a detailed cross-sectional view of a sealing element as applied in the switch according to FIG. 1;

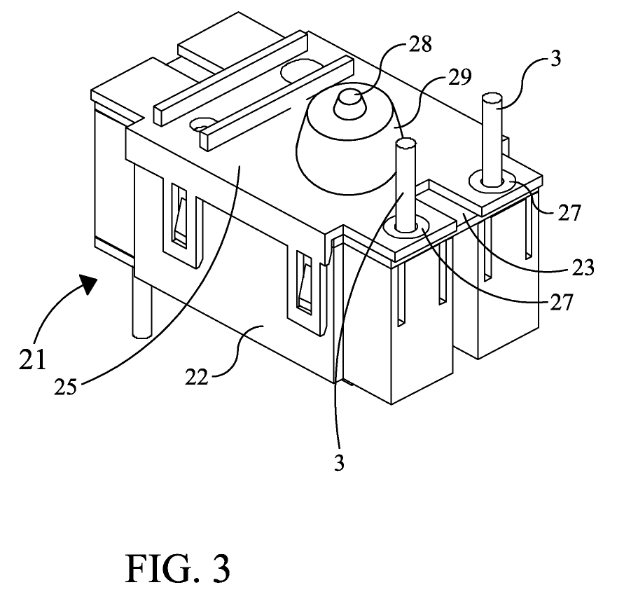

FIG. 3 is a perspective view of another embodiment of a switch according to the invention;

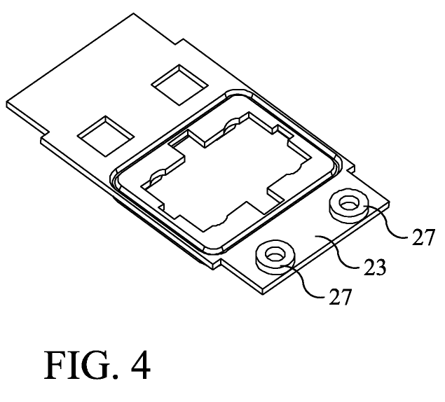

FIG. 4 is a perspective view of a first combined sealing element in the switch shown in FIG. 3; and

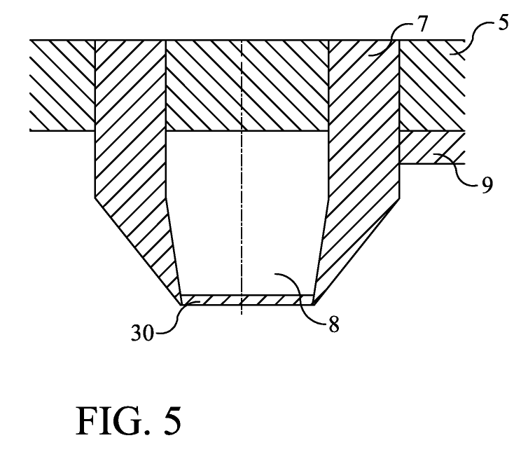

FIG. 5 is a view corresponding with FIG. 4 of a variant of the sealing element.

FIG. 1 shows half of a housing 2 of a switch designated as a whole with 1. The switch is of the type which is applied in electrical hand tools. Switch 1 is adapted to control the power of the electric motor arranged in the electrical hand tool. The drawing shows how two wires 3,4 are connected to switch 1. Switch 1 comprises for this purpose an opening 6 in a first wall 5, in which opening is placed a sealing element 7. Sealing element 7 is shown in more detail in FIG. 2.

Opening 6 arranged in wall 5 has a round cross-section. A sealing element designated as a whole with 7 is placed in this opening 6. Sealing element 7 is provided with a central opening 8 through which the connected wire 3 extends. Sealing element 7 comprises a substantially cylindrical part 7A with a substantially cylindrical opening 8A and a substantially conical part 7B. Conical part 7B is provided with a conical opening 8B. Sealing element 7 is provided with a co-moulded part 9, which is fixed in switch housing 2 in the manner shown in FIG. 1.

Wire 3 comprises a solid core 10 which is enclosed by an insulating sheath 11. Before the wire is inserted through the seal into the switch, a part of the insulating sheath 11 is removed over a distance A. This part of core 10 must after all be placed into contact with a conductive part 12 of the switch. The dimensioning of sealing element 7 is such that sealing element 7 engages on the part of wire 3 provided with insulation. The smallest diameter of opening 8B of conical part 7B of the sealing element is herein chosen to be slightly smaller than the external diameter of insulating sheath 11. When wire 3 is inserted the stripped part 10 of wire 3 will initially be placed through opening 8 arranged in sealing element 7. The conical part 8A of the opening herein fulfills a guiding function for the purpose of facilitating the insertion. When inserted further, insulating sheath 11 of the wire will come into contact with conical part 7B of sealing element 7 and, as wire 3 is moved even further inward, the insulating layer 11 and the lower edge of conical part 7B will be deformed. The degree of deformation depends on the elasticity of the two components. A more elastic material is generally chosen for sealing element 7 than for the generally harder insulating sheath 11. The deformation will then take place substantially in sealing element 7. Due to this deformation a mechanical stress is built up in the sealing element, whereby the material of sealing element 7 is urged closely against insulating layer 11, whereby a good sealing results and even the finest dust cannot penetrate switch housing 2.

Use is made in the foregoing of a wire 3 with a round cross-section. A sealing element 7 with a round opening is then applied. It is possible in principle to make use of a sealing element 7 with a non-round cross-section for wires with a non-round cross-section, such as ribbon cable, and for connectors.

It will be apparent that the invention is not limited either to wires with a solid core; the invention also applies to wires with a core consisting of separate wires. It is pointed out here that the application of a solid core provides the option of allowing the seal to engage on an unstripped part of the wire, i.e. on the core itself.

In the embodiment shown here the core 10 of wire 3 is engaged by a spring 16 which presses core 10 against contact 12. This spring not only has the function of establishing and maintaining a contact between core 10 and contact 12, but also the function of a mechanical locking of wire 10. This implies that the sealing element only has to provide for sealing and does not have to be dimensioned for mechanical locking of wire 10.

It is possible in principle for the fit of sealing element 7 in wall 5 to be such that sealing element 7 is fixed by the fit. In the configuration shown in FIG. 1 fixation of the sealing element takes place by means of an extra element, i.e. a co-moulded part 9. This co-moulded part 9 is provided with a groove 14, which is engaged by a protrusion 15 of wall 5.

FIG. 3 shows a switch 21 of a different type in which sealing elements according to the present invention are also applied. This switch 21 is coupled on its upper surface to two wires 3. For sealing of the wires in the switch use is made of two sealing elements 27, which each correspond substantially with sealing element 7 described with reference to FIGS. 1 and 2. In order to facilitate the production the two sealing elements 27 are implemented in a single component 23, which extends over the whole surface of upper wall 25 of the switch. It has hereby become possible for the component in question to not only fulfill the sealing function for the connecting wires but also the sealing function of upper wall 25 on the rest of housing 22 of switch 21. For this purpose the component 23 extends over the whole surface of the upper wall of the housing. It is noted incidentally that the switch is also provided with a control element in the form of a pin 28 which is movable in its axial direction. The pin extends through an opening made in housing 23. A bellows 29 manufactured from flexible material is arranged in order to make a seal between movable pin 23 and the housing. This bellows can also be formed integrally with component 23.

FIG. 4 shows component 23 in its entirety; this shows the presence of the two sealing elements 27.

It will be apparent that it is possible to vary the configurations shown in the drawings in numerous ways without departing from the invention; it is thus possible in particular to vary the number of sealing elements per wall.

Finally, FIG. 5 shows a cross-sectional view corresponding with FIG. 2 of a sealing element according to the invention, wherein a wall 30, which can be pierced by a wire, is arranged on the underside of sealing element 7.

1. Switch for electrical hand tools, comprising:
a housing;
switch means incorporated in the housing;
at least one wire opening arranged in the housing for throughfeed of a connecting wire;
at least one contact incorporated in the housing for making galvanic contact between a connecting wire placed through the opening and the switch means; and
at least one sealing element fitting into the at least one wire opening, manufactured from a flexible material and provided with a throughfeed opening, characterized in that the sealing element has a first part in which a throughfeed opening has a diameter decreasing in the direction toward the interior of the housing and that the sealing element is provided with a fixation element for fixing the position of the sealing element relative to the housing.

2. Switch as claimed in claim 1, characterized in that at least two wire openings are arranged in a same wall of the housing, each for throughfeed of a connecting wire, that at least two contacts are arranged in the housing, each for making galvanic contact between a connecting wire placed through the opening and the switch means, that a sealing element is placed fitting into each of the wire openings, that the sealing elements are accommodated together in a single substantially flat, plate-like body formed by the fixation element.

3. Switch as claimed in claim 2, characterized in that the plate-like body extends parallel to and on the inner side of a wall of the housing functioning as a cover of the housing and extends between the housing and the wall.

4. Switch as claimed in claim 1, characterized in that the opening formed in its first part is at least partly conical, that the sealing element has a second part in which the throughfeed opening is substantially cylindrical, and wherein the cylindrical part of the throughfeed opening connects to the part of the opening with the shape of a truncated cone at the end with the largest diameter.

5. Switch as claimed in claim 4, characterized in that the first part of the sealing element has a diameter which decreases toward the interior of the housing and that the first part of the sealing element has the form of a truncated cone on its outer side.

6. Switch as claimed in claim 1, characterized in that the second part of the sealing element is enclosed on its periphery over at least a part of its height by the housing.

7-10. (canceled)

11. Switch as claimed in claim 1, characterized in that the throughfeed element is manufactured from a material with a hardness lying between 25 and 70 Shore A.

12. Switch as claimed in claim 1, characterized in that the throughfeed element is manufactured from polyamides, natural rubbers or synthetic rubber.

13. Switch as claimed in claim 1, characterized in that a thin wall which can be pierced when a wire is inserted is arranged in the throughfeed opening.

14. Switch as claimed in claim 13, characterized in that the pierceable wall is arranged in the throughfeed opening at the position with the smallest diameter.

15. Combination of a wire stripped on at least one end and a switch as claimed in claim 1, the wire being connected to the switch, characterized in that the diameter of the insulated part of the wire is greater than the smallest diameter of the throughfeed opening.

16. Combination as claimed in claim 15, characterized in that the combination comprises at least two wires, wherein at least two wire openings, each for throughfeed of a connecting wire, are arranged for each of the wires in the housing, that at least two contacts are arranged in the housing, each for making galvanic contact between a connecting wire placed through the opening and the switch means, that a sealing element is placed fitting into each of the wire openings and that the sealing elements are accommodated together in a single body.

17. Combination as claimed in claim 16, characterized in that the diameter of at least one of the wires is smaller than that of the other wires, and that the sealing elements through which the wire with the smaller smallest diameter extends has a throughfeed opening of smaller diameter than the throughfeed opening for the other wires.

18. Electrical hand tool, characterized by a switch as claimed in claim 1.

19. Electrical hand tool as claimed in claim 18, characterized in that the electrical hand tool is formed by a machining electrical hand tool.
